(19) United States
(12) Patent Application Publication
(10) Pub. No.: US 2005/0111029 A1
(43) Pub. Date: May 26, 2005

(54) Systems and methods for providing printer status information to users

(76) Inventor: Dave R. Dehart, Boise, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/720,423

(22) Filed: Nov. 25, 2003

(51) Int. Cl. G06F 15/00

(52) U.S. Cl. 358/1.15; 358/1.1

(57) ABSTRACT

Systems for providing printer status information to a user are provided. In this regard, an exemplary system comprises a status link system. The status link system is operative to display a link to an embedded web server (EWS) of a printer to a user in response to a user input. The EWS maintains status information corresponding to the printer. The link is displayed in association with a dialog box. In response to the user actuating the link, the user is provided with the status information corresponding to the printer. Methods and other systems also are provided.

### TECHNICAL FIELD

The present invention generally relates to printers.

### DESCRIPTION OF THE RELATED ART

When using a printer, oftentimes, a user may find it helpful to determine the status of the printer. Conventionally, information corresponding to printer status is obtained by using bi-directional communication between a computer system operated by the user and the printer. In using the bi-directional communication, the computer system prompts the printer to provide a return message that contains the status information. Unfortunately, however, various problems can be associated with bi-directional communication.

By way of example, incorporation of bi-directional communication capabilities typically adds to the size of the printer driver associated with a printer. Due to the inherent complexity of such a printer driver, installation problems can be encountered. Specifically, the systems can be difficult to install and, even when installed, can cause operating problems in the host computer system. Because these problems can exist, information for establishing bi-directional communication may not be loaded onto a computer system. Thus, such a computer system typically lacks the ability to determine status information corresponding to a printer.

### SUMMARY

Systems and methods for providing printer status information to a user are provided. In this regard, an embodiment of a system for providing printer status information comprises a status link system. The status link system is operative to display a link to an embedded web server (EWS) of a printer to a user in response to a user input. The EWS maintains status information corresponding to the printer. The link typically is displayed in association with a dialog box. In response to the user actuating the link, the user is provided with the status information corresponding to the printer.

An embodiment of a method for providing printer status information comprises: displaying a dialog box to a user in response to a user input, the dialog box including a link to an EWS of a printer, the EWS maintaining information corresponding to the printer; and in response to the user actuating the link, providing the user with the status information corresponding to the printer.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The components in the drawings are not necessarily to scale relative to each other. Like reference numerals designate corresponding parts throughout the several views.

FIG. 1 is a schematic diagram depicting an embodiment of a system for providing printer status information to a user.

FIG. 2 is a flowchart depicting an embodiment of a method for providing printer status information to a user.

FIG. 3 is a schematic diagram of a computer or processor-based device that can be used to implement a method for providing printer status information to a user.

FIG. 4 is a flowchart depicting functionality of an embodiment of a status link system.

FIG. 5 is an embodiment of a dialog box of a system for providing printer status information to a user.

FIG. 6 is a screen shot of the dialog box of FIG. 5, depicting a list of printers from which the user may select for printing.

FIG. 7 is a screen shot of the dialog box of FIGS. 5 and 6, after the user has selected another printer.

FIG. 8 is a screen shot of the dialog box of FIGS. 5-7, depicting pages displayed to the user upon actuation of the Properties actuator.

FIG. 9 is a screen shot of the dialog box of FIGS. 5-8, depicting the status page.

### DETAILED DESCRIPTION

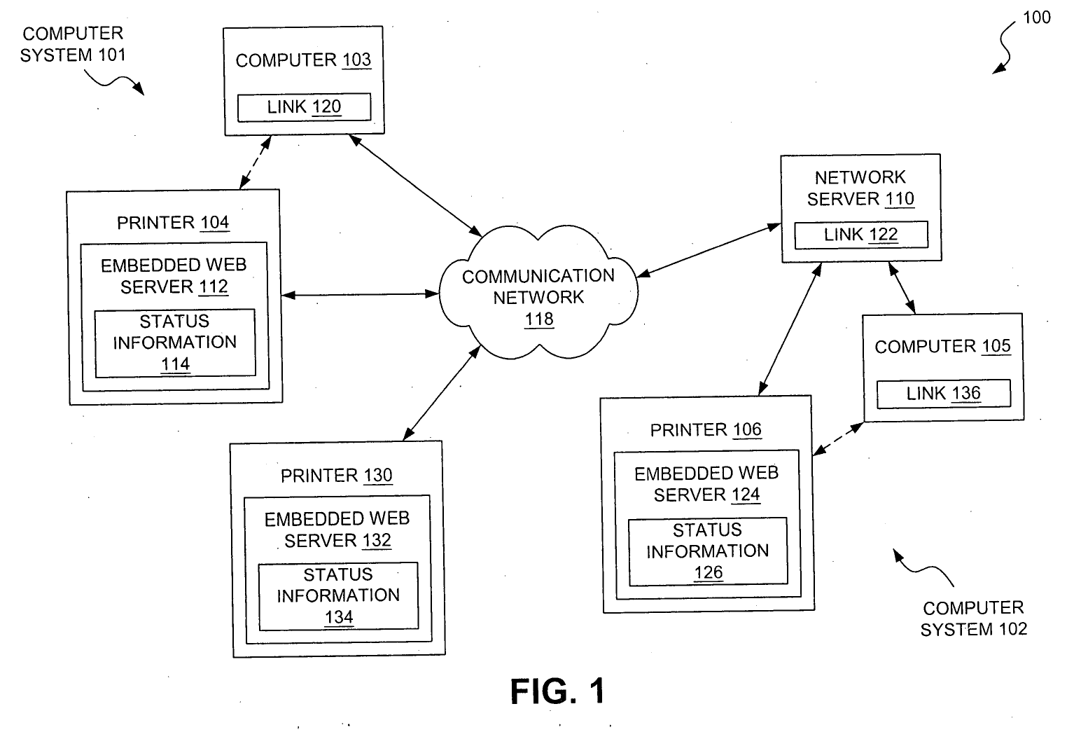

As will be described in detail here, systems and methods can provide a user with access to printer status information in a manner that is potentially more efficient than is conventionally accomplished. By way of example, some embodiments provide a link, e.g., an Internet hyperlink, which is automatically displayed to a user when a print dialog box is displayed. Thus, if the user desires information regarding the status of a printer, the user can actuate the link, which directs the user to the embedded web server (EWS) of the printer. Since the EWS maintains information corresponding to the status of the printer, status information can be accessed by the user. An embodiment of a printer status information system will now be described with respect to FIG. 1.

As shown in FIG. 1, printer status information system 100 includes a computer system 101 and a computer system 102, each of which includes a computer and a printer. Specifically, computer system 101 includes a computer 103 and a printer 104, and computer system 102 includes a computer 105 and printer 106. Computer system 102 also includes a network server 110. Note that each of the printers incorporates an EWS that maintains information corresponding to the status of the printer with which it is associated. Thus, with respect to printer 104, EWS 112 includes status information 114, which comprises status information regarding printer 104. By way of example, status information can include the amount of supplies remaining, tray configuration, amount of memory installed, past errors, network settings, and web links for product support and ordering of supplies. The EWS also enables a user to configure the printer remotely.

Since status information 114 is maintained by EWS 112, the status information is provided in a format that is accessible via a communication network. For instance, the status information can be provided in HTML format and can be accessible via the Internet.

In the embodiment of FIG. 1, EWS 112 and its associated status information 114 can be accessed via communication network 118. The communication network 118 enables computer 103 to communicate with printer 104. Note that, in other embodiments, computer 103 can communicate directly with printer 104, such as via a printer cable. Direct communication is depicted by the dashed line interconnecting computer 103 and printer 104.

In order for a user of computer 103 to obtain status information corresponding to printer 104, link 120 is provided. Specifically, link 120 is displayed to the user, such as via a display device of computer 103. Link 120 can be actuated to establish a communication link between computer 103 and the EWS 112 of printer 104. By way of example, link 120 can be a Hyperlink that is displayed to the user when operating computer 103.

Information for establishing link 120 can be provided in various manners. For instance, the information can be provided during installation of the printer driver associated with printer 104. By way of further example, the information could be provided to computer 103 when printer 104 provides information to computer 103 indicating that printer 104 is available for printing. Clearly, various manners can be used for providing the information associated with link 120 to computer 103.

Referring now to computer system 102, computer system 102 includes a computer 105, a printer 106 and network server 110. Therefore, computer system 102 can be attributed to a local area network (LAN). In contrast to computer 103, computer 105 does not locally store a link to information corresponding to the status of printer 1062. In this embodiment, information corresponding to the link, i.e., link 122, is maintained by network server 110. Thus, when a user of computer 105 desires status information corresponding to printer 106, computer 105 accesses information corresponding to link 122 that is stored on the network server 110, and uses that information for establishing a communication link with printer 106. As described before with respect to printer 104, once a communication link is established, the EWS 124 of printer 106 is able to provide status information 126 to computer 105. In this embodiment, the status information 126 is provided from printer 106 to the network server 110 and then to computer 105. However, in other embodiments, printer 106 can communicate directly with computer 105, as indicated by the dashed line.

The embodiment of the printer status information system 100 depicted in FIG. 1 also includes a printer 130. Printer 130 includes an EWS 132 that maintains status information 134 corresponding to printer 130. Note that computer 105 stores information corresponding to a link 136 for accessing the status information 134. Thus, in some embodiments, even when a computer is associated with a LAN, that computer can locally store information for accessing status information of a printer that is not associated directly with the LAN.

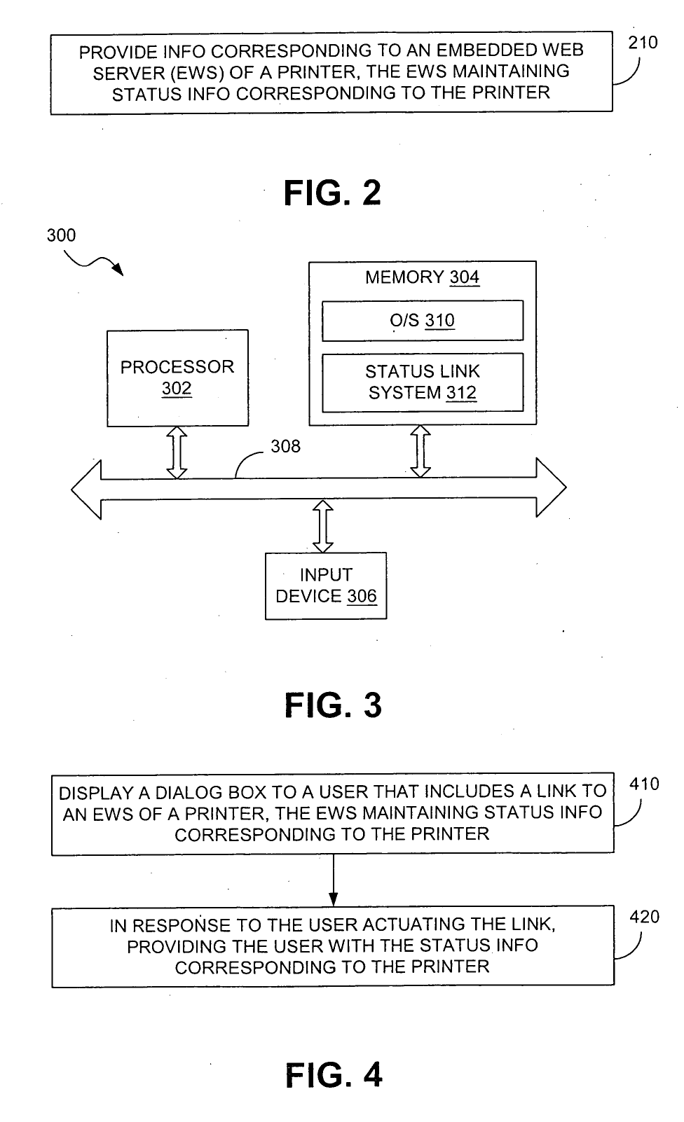

Reference will now be made to the block diagram of FIG. 2, which depicts an embodiment of a method for providing printer status information to a user. As shown in FIG. 2, the method includes providing information corresponding to an EWS of a printer to a user. Specifically, the information can correspond to an IP address of the EWS, with the EWS maintaining status information corresponding to the printer. By providing access to the user to status information, such as via a link, it may be possible to forego providing bi-directional communication functionality in a computer system.

The exemplary functionality described with respect to the block diagram of FIG. 2 can be implemented in hardware, software, firmware and/or combinations thereof. Reference will now be made to an embodiment of a system that is implemented in software and executed by a computer. In this regard, FIG. 3 is a schematic diagram of a representative computer that can be used for implementing an embodiment of a status link system for providing the aforementioned functionality.

Generally, in terms of hardware architecture, computer 300 includes a processor 302, memory 304, and one or more input and/or output (I/O) devices 306 that are communicatively coupled via a local interface 308. The software in memory 304 can include one or more separate programs, each of which comprises an ordered listing of executable instructions for implementing logical functions. In the example of FIG. 3, the software in the memory 304 includes an operating system (O/S) 310 and an embodiment of a status link system 312.

When status link system 312 is implemented in software, it should be noted that the status link system can be stored on any computer-readable medium for use by or in connection with any computer-related system or method. In the context of this document, a computer-readable medium is an electronic, magnetic, optical, or other physical device or means that can contain or store a computer program for use by or in connection with a computer-related system or method. The status link system 312 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

A computer-readable medium can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

Functionality of the embodiment of the status link system 312 of FIG. 3 is presented in the flowchart of FIG. 4. It should be noted that, in some alternative implementations, the functions noted in the various blocks of this and/or other flowcharts depicted in the accompanying disclosure may occur out of the order depicted. For example, two blocks shown in succession in FIG. 4 may be performed concurrently.

As shown in FIG. 4, the functionality (or method) may be construed as beginning at block 410, where a dialog box is displayed to the user. For example, the dialog box can include a link to an EWS of a printer. Typically, the EWS maintains status information corresponding to the printer about which the user desires information. In block 420, the user is provided with the status information corresponding to the printer in response to the user actuating the link. By way of example, actuation of the link establishes communication between the computing device that displayed the link and the EWS of the of the printer about which the user desires the status information.

Reference will now be made to multiple representative screen shots that depict examples of dialog boxes that can be displayed to a user by an embodiment of a system for providing printer status information. As shown in FIG. 5, a representative print dialog box 500 is displayed that includes various information about the printer that is being used by a user. By way of example, such a print dialog box can be displayed to a user when operating a word processing program when the print icon and/or file/print is selected. Note that the print dialog box identifies the currently-selected printer, which is indicated in the name field 510. Also note that a link is displayed in status information field 520. By actuating this link, status information corresponding to the currently-selected printer is provided to the user by establishing communication that permits access to the EWS of the printer. As mentioned before, the EWS maintains information such as that corresponding to the status of the printer.

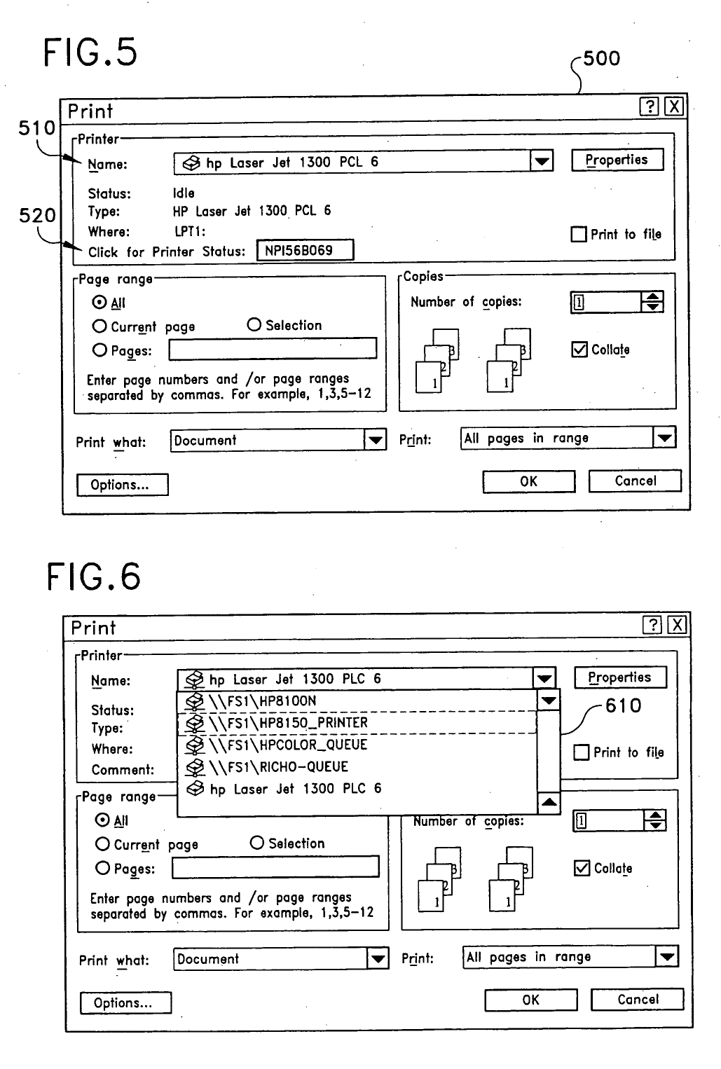

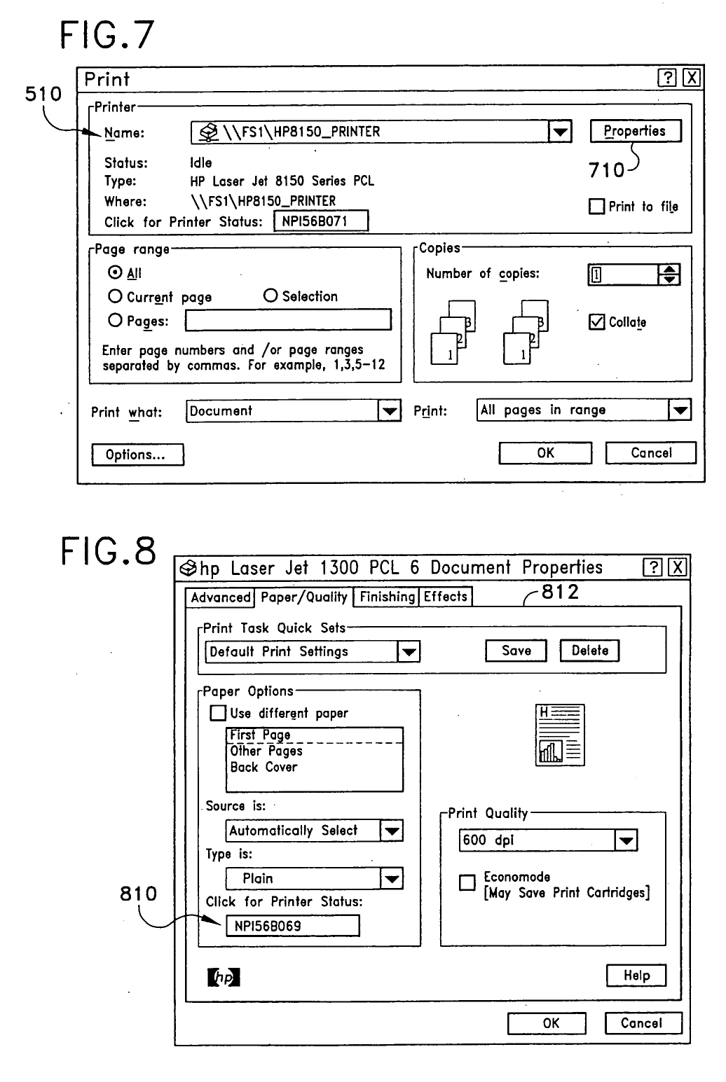

As depicted in FIG. 6, the user has opened a drop-down menu 610 and has highlighted another printer for use. In this case, the user has highlighted printer HP8150. Upon selection of the HP8150 printer, that printer is now designated for use and is indicated in the name field 510 of FIG. 7. Note also that the status linked in the status information field 520 has changed to correspond to the newly-selected printer.

In some embodiments, in addition to or in lieu of a link being displayed on the first page of the printer dialog box, a link may be displayed on another page. By way of example, such a link could be provided on one or more of the pages that are displayed to the user upon actuating the Properties actuator 710.

In some embodiments, upon actuating a Properties actuator of a print dialog box, information such as that depicted in FIG. 8 is displayed to the user. Preferably, a link to status information provided by an EWS of a printer is displayed on the first page displayed to the user upon actuation of the Properties actuator. This is depicted in FIG. 8, in which link 810 is provided on the paper/quality page 812.

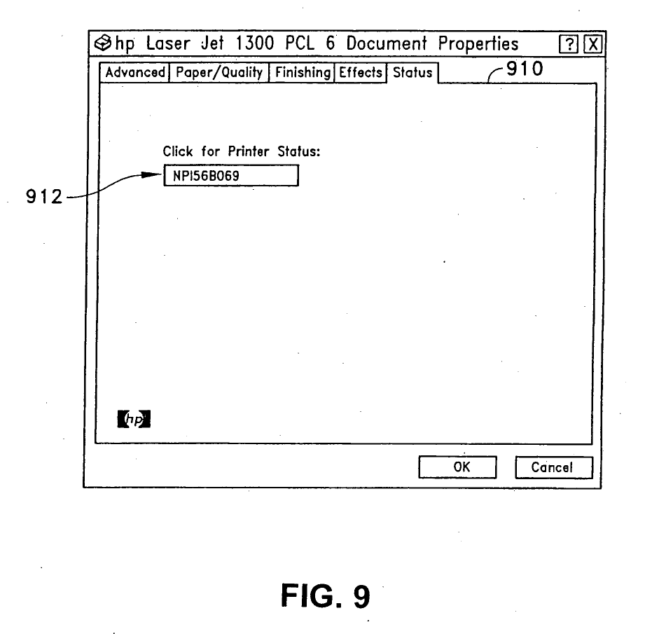

In other embodiments, such as depicted in FIG. 9, an additional page can be added to the Properties pages. For instance, as shown in FIG. 9, a status page 910 has been added. This page includes a link 912 to the EWS of the selected printer.

It should be emphasized that many variations and modifications may be made to the above-described embodiments. All such modifications and variations are intended to be included herein within the scope of this disclosure and protected by the following claims.

1. A method for providing printer information to a user, the method comprising:
displaying a dialog box to a user in response to a user input, the dialog box including a link to an embedded web server (EWS) of a printer, the EWS maintaining status information corresponding to the printer; and
in response to the user actuating the link, providing the user with the status information corresponding to the printer from the EWS.

2. The method of claim 1, wherein:
the dialog box comprises multiple pages; and
in displaying the dialog box to the user, the link is provided on a first of the pages that is displayed.

3. The method of claim 2, wherein the dialog box is a print dialog box.

4. The method of claim 3, wherein the print dialog box comprises a Properties actuator, which, in response to actuation thereof, displays multiple pages; and
the link is provided on a first of the pages displayed to the user in response to actuating the Properties actuator.

5. The method of claim 3, wherein the print dialog box comprises a Properties actuator, which, in response to actuation thereof, displays multiple pages; and
the link is provided on one of the pages displayed to the user in response to actuating the Properties actuator.

6. The method of claim 3, wherein the print dialog box comprises a Properties actuator, which, in response to actuation thereof, displays a Layout page and an About page; and
the link is provided on the About page.

7. The method of claim 1, wherein the EWS comprises information corresponding to a service manual of the printer.

8. The method of claim 1, wherein:
the method additionally comprises providing a list of printers from which the user is able to print, each of the printers having corresponding printer information associated therewith; and
in response to the user selecting one of the printers of the list, a corresponding link to a EWS that comprises the printer information associated with the printer selected is displayed.

9. A method for providing printer status information to a user, the method comprising:
providing information corresponding to a link to a user of a printer, the link corresponding to an embedded web server (EWS), the EWS maintaining status information corresponding to the printer, the link being displayable to the user in response to a user input such that, in response to the user actuating the link, the user is provided with the status information corresponding to the printer.

10. The method of claim 9, wherein, in providing information corresponding to a link to a user of a printer, the information corresponding to the link is installed in the printer.

11. The method of claim 9, wherein, in providing information corresponding to a link to a user of a printer, the user installs the information corresponding to the link in the printer.

12. The method of claim 9, wherein:
the user has access to multiple printers; and
the method further comprises:
providing the user with a link to an EWS that comprises printer information corresponding to one of the multiple printers currently selected by the user.

13. A system for providing printer status information to a user, the system comprising:
a status link system operative to display a link to an embedded web server (EWS) of a printer to a user in response to a user input, the link being displayed in association with a dialog box, the EWS maintaining status information corresponding to the printer such that, in response to the user actuating the link, the user is provided with the status information corresponding to the printer.

14. The system of claim 13, further comprising:
a computer system comprising:
a processor operative to execute instructions;
memory communicating with the processor and operative to store instruction executable by the processor; and
printer interface instructions stored by the memory, the printer interface instructions being operative to display a print dialog box to the user in response to a user input, the link being displayed in association with the print dialog box.

15. The system of claim 13, wherein:
the printer interface instructions are executable to display a list of printers with which the computer system has access, each of the printers having corresponding printer information associated therewith; and
in response to the user selecting one of the printers of the list, the status link system is operative to display a corresponding link to an EWS that maintains the printer status information associated with the printer selected.

16. The system of claim 13, further comprising:
a printer communicating with the computer system.

17. The system of claim 13, wherein the status link system is stored by the printer.

18. The system of claim 13, wherein the status link system is stored by the computer system.

19. The system of claim 13, wherein the status link system is stored on a computer-readable medium.

20. The system of claim 13, further comprising:
means for displaying the link.
